(19) United States
(12) Patent Application Publication
(10) Pub. No.: US 2008/0074675 A1
(43) Pub. Date: Mar. 27, 2008

(54) Flying height resolution improvement method

(75) Inventors: Dongman Kim, Campbell, CA (US); Michael T. Sullivan, Fremont, CA (US)

Correspondence Address: IRELL & MANELLA LLP, 840 NEWPORT CENTER DRIVE, SUITE 400, NEWPORT BEACH, CA, 92660, US

(73) Assignee: Samsung Electronics Co., Ltd., Suwon City (KR)

(21) Appl. No.: 11/528,300

(22) Filed: Sep. 26, 2006

(51) Int. Cl. G01B 11/02

(52) U.S. Cl. 356/507

(57) ABSTRACT

A flying height tester used to measure the flying height of a head of a hard disk drive. The flying height tester includes a transparent substrate that has an index of refraction greater than 1.5. Utilizing a substrate with an index of refraction no greater than 1.5 improves the flying height sensitivity of the tester.

### BACKGROUND OF THE INVENTION

1. Field of the Invention

The present invention relates to a transparent substrate that is used in a flying height tester that measures the height of an air bearing between a disk and a recording head of a hard disk drive.

2. Description of the Background

Hard disk drives contain heads which magnetize and sense the magnetic fields of rotating magnetic disks. Each head has a slider surface that creates an air bearing between the head and the rotating disk. The air bearing prevents contact and corresponding mechanical wear of the recording head. Each head is mounted to a flexure arm that is attached to an actuator arm.

Some of the heads are characterized in a flying height tester. Flying height testers measure the height of the air bearing to insure that the head complies with manufacturing specifications. Flying height testers typically contain a loader which places each slider adjacent to a rotating transparent disk. A beam of light is directed through the glass disk and reflected off of the head. Multiple reflections occur at the glass/air and head/air interfaces, creating an interference pattern that is detected and analyzed by the tester to determine the flying height of the head.

The height of the air bearing is a sinusoidal function of the detected light intensity. FIG. 1 shows a typical intensity versus flying height curve for a flying height tester at 450 nm wavelength. Some heads create a trailing edge flying height of 5 nanometers (“nm”) or less, and a leading edge flying height between 210-230 nm. These heights are near the minimas of the curve. The sensitivity at the minimas and maximas of the curve is essentially zero because of the infinite slope at these points. Low sensitivity produces less accurate test results.

There have been various approaches to improving the sensitivity of flying height testers. These approaches include elaborate calibration techniques and/or utilizing multiple wavelengths to create multiple out of phase intensity versus air bearing curves height curves.

### BRIEF SUMMARY OF THE INVENTION

A flying height tester that is used to measure the flying height of a head of a hard disk drive. The tester includes a transparent substrate that has an index of refraction greater than 1.5.

### BRIEF DESCRIPTION OF THE DRAWINGS

FIG. 1 is a graph showing an intensity versus flying height for a flying height tester of the prior art;

FIG. 2 is an illustration of a flying height tester;

FIG. 3 is a graph showing an intensity versus flying height for the flying height tester.

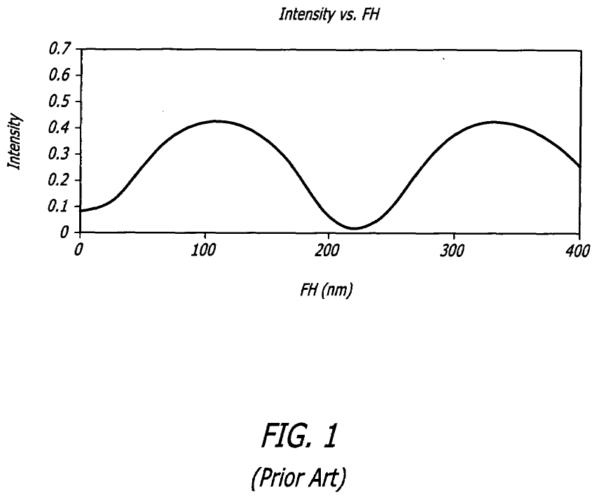

### DETAILED DESCRIPTION

Disclosed is a flying height tester used to measure the flying height of a head of a hard disk drive. The flying height tester includes a transparent substrate that has an index of refraction greater than 1.5. Utilizing a substrate with an index of refraction greater than 1.5 improves the flying height sensitivity of the tester.

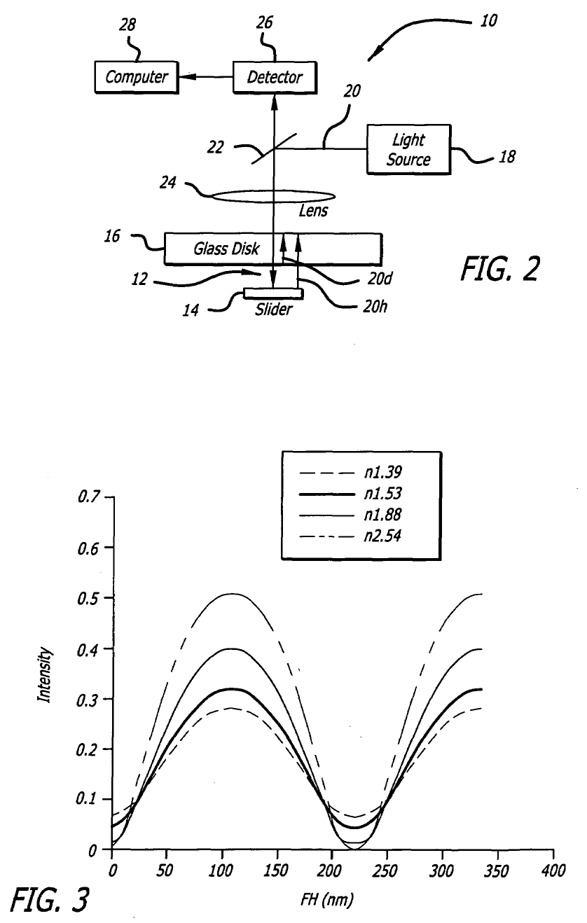

Referring to the drawings more particularly by reference numbers, FIG. 2 shows a flying height tester 10. The flying height tester 10 is typically used to measure the height of an air bearing 12 created between a head 14 and a rotating transparent disk 16. The head 14 is mounted to a loader (not shown) of the tester 10. The heads 14 are loaded into the tester and then removed after testing.

The transparent disk 16 is rotated by a spindle (not shown). Rotation of the disk 16 induces a flow of air above the head 14. The head 14 includes a slider surface that induces the formation of the air bearing 12 between the head 14 and the rotating disk 16.

The flying height tester 10 further includes a light source 18 that emits a beam of light 20. The tester 10 may have a beam splitter 22 and a lens 24 that direct the beam of light through the disk 16 and onto the head 14. Part of the light beam 20h is reflected off the head 14 and back through the disk 16. Another part of the beam 20d reflects off the interface between the disk 16 and the air bearing 12. The two reflected light beams 20h and 20d create an interference pattern that is detected by a photodetector 26. The photodetector 26 is coupled to a computer 28 that can determine the height of the air bearing 12 from the interference pattern. By way of example, the flying height may be computed using the following equations

$$Iout = Iin \frac{{r}^{2} + {s}^{2} - 2 rs cos ( \frac{4 π h}{λ} + {φ}_{s} )}{1 + {r}^{2} {s}^{2} - 2 rs cos ( \frac{4 π h}{λ} + {φ}_{s} )} , \qquad ( 1 )$$

where;

h=the flying height;

Iin=the intensity of light provided by the light source;

Iout=the intensity of the light detected by the photodetector;

r=the amplitude reflectivity off lower glass disk;

s=the amplitude reflectivity off the head surface;

λ=the wavelength of the light source;

$${φ}_{s} = arctan \frac{2 {k}_{s}}{{n}_{s}^{2} + {k}_{s}^{2} - 1} ;$$

where n is the slider's real component of the index of refraction and k is the slider's imaginary component of the index of refraction.

The computer can calculate the flying height using the measured intensity Iout.

The substrate has an index of refraction that is greater than 1.5. FIG. 3 plots flying heights versus measured intensity Iout for different substrate indexes of refraction. The curves were generated using a wavelength of 450 nanometers. Intensity v. flying height curves for an index of greater than 1.5 has a larger slope and thus a larger sensitivity than curves with indices of greater than 1.5. When testing flying heights less than 10 nanometers, particularly for heights 5 nanometers of less, it is desirable to utilize a system that has the greatest sensitivity possible. It is therefore desirable to utilize a transparent substrate with an index of refraction no greater than 1.5.

By way of example, a substrate 16 constructed from dense lanthanum flint (LaSFN9) glass has an index of refraction of 1.88. A substrate 16 constructed from BK7doped with constituents to achieve the desired index of refraction can also be utilized. Furthermore, external forces (either tensile or compressive) can be utilized to increase the index of refraction during operation of the tester.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed:

1. A disk of an optical tester used to test a flying height of a head of a hard disk drive, comprising:
a transparent substrate that has an index of refraction greater than 1.5.

2. The disk of claim 1, wherein said transparent substrate is constructed with dense lanthanum flint (LaSFN9) glass.

3. A flying height tester for a head of a hard disk drive, comprising:
a transparent substrate that has an index of refraction greater than 1.5;
a light source that directs a beam of light through said transparent substrate and onto the head, wherein the beam of light is reflected from the head; and,
a photodetector that detects the reflected light beam.

4. The tester of claim 3, wherein said transparent substrate is constructed with dense lanthanum flint (LaSFN9) glass.

5. The tester of claim 3, further comprising a computer coupled to said photodetector.

6. A method for measuring a flying height of a head of a hard disk drive, comprising:
flying a head adjacent to a transparent substrate that has an index of refraction greater than 1.5;
directing a beam of light through the transparent substrate so that the beam of light is reflected from the head;
detecting the reflected light beam; and,
processing the detected light beam to determine a flying height of the head.

7. The method of claim 6, wherein the transparent substrate is constructed with dense lanthanum flint (LaSFN9) glass.
